(19) United States
(12) Patent Application Publication
(10) Pub. No.: US 2025/0153834 A1
(43) Pub. Date: May 15, 2025

(54) DRIVE UNIT FOR AN ELECTRIC OUTBOARD MOTOR

(71) Applicant: Torqeedo GmbH, Wessling (DE)

(72) Inventors: Anton SPENGLER, Wessling (DE); Marcel STRICKER, Wessling (DE)

(21) Appl. No.: 18/940,990

(22) Filed: Nov. 8, 2024

(30) Foreign Application Priority Data
Nov. 10, 2023 (DE) 10 2023 131 250.2

(51) Int. Cl. B63H 20/32; B63H 20/14

(52) U.S. Cl. CPC B63H 20/32; B63H 20/14

(57) ABSTRACT

A rear cap is provided for forming a component of a housing of a drive unit. The rear cap includes a cover section that closes the housing at a rear and includes a propeller shaft opening that defines an axial direction and through which a propeller shaft of the drive unit is guided out of the housing; and a hollow-cylindrical mounting section that, as seen in the axial direction, is arranged on a side facing away from the propeller shaft opening. The mounting section has a cylindrical mounting surface with a mounting thread, such that the rear cap is configured to be screwed onto a corresponding housing-side thread of the housing.

### CROSS REFERENCE TO RELATED APPLICATIONS

The current application claims priority to German Application No. 10 2023 131 250.2, filed Nov. 10, 2023, the contents of which are hereby incorporated by reference.

### TECHNICAL FIELD

The present invention relates to a drive unit for an electric boat drive, for example for an outboard motor or for a pod drive, in particular a rear cap for such a drive unit.

### BACKGROUND

In the field of boat drives, outboard motors or pod drives with electric drive are known. Electric drives have some advantages over internal combustion engines. Thus, electric outboard motors are very quiet during operation and do not emit any exhaust gases into the environment. Contamination of the water during refueling or unintentionally escaping oil can be ruled out.

The drive unit of such an outboard motor can comprise a multi-part housing, for instance in order to be able to open and service the drive unit. In this case, it is customary for the drive unit to comprise a rear cap of metal which is arranged on the side of the propeller and which is mechanically machined, coated and fastened to the housing of the drive unit by screws.

The multi-part nature of the housing of the drive unit can, if different metallic materials are used, lead to galvanic corrosion on contact with water, in particular seawater. In addition, the assembly process of the rear cap is complex since both a number of screws have to be fastened and the axiality of the rear cap relative to the housing has to be ensured.

### SUMMARY OF THE INVENTION

An object of the invention is to provide an improved drive unit for an electric outboard motor or a pod drive, in particular an improved rear cap for such a drive unit.

The object is achieved by a rear cap having the features of claim 1 and a drive unit having the features of claim 11. Advantageous developments follow from the subclaims, the following description of the invention and the description of preferred exemplary embodiments.

The rear cap according to the invention is designed for a drive unit of an electric outboard motor or of a pod drive. In this case, the rear cap forms a component of a housing of the drive unit, in particular on the propeller side of the drive unit. The propeller side of the drive unit is also referred to herein as “rear side”.

The rear cap has a cover section which closes the housing at the rear. The cover section has a propeller shaft opening which defines an axial direction and through which a propeller shaft of the drive unit, which propeller shaft extends in the axial direction, can be guided out of the housing to the outside. The drive unit furthermore has a hollow-cylindrical mounting section which, as seen in the axial direction, is arranged on the side facing away from the propeller shaft opening. The mounting section extends as a cylindrical wall on the outer circumference of the cover section. The rear cap thus has a bowl shape, the base of which is formed by the cover section and is bordered on the outer circumference by the mounting section.

The mounting section has a cylindrical mounting surface with a mounting thread, by means of which the rear cap as a whole can be screwed onto a corresponding housing-side thread of the housing. The position of the mounting surface preferably corresponds to the nominal diameter of the mounting thread, i.e. the greatest diameter of the mounting thread.

The assembly of the rear cap described above is managed by means of the integrated mounting thread without additional fastening means, such as screws, etc. The assembly process is thereby accelerated and can be carried out reliably. The mounting thread additionally provides, as a synergistic function, a seal against the penetration of water or other external media into the drive unit.

The mounting thread is preferably designed as an internal thread and is seated on the mounting surface of the mounting section in such a way that the flanks of the mounting thread extend as projections from the mounting surface into the interior of the hollow-cylindrical mounting section. In this way, the handling and assembly capability of the rear cap are further improved.

The mounting section preferably has, next to the mounting surface, as seen in the axial direction in the direction of the cover section (i.e. at the rear), a cylindrical centring surface which is designed to ensure centring relative to the housing during the assembly of the rear cap, in that the centring surface enters into a form fit with a corresponding housing-side centring surface of the housing. The integration of the centring surface into the mounting section increases the reliability of the assembly process, in particular with regard to the axiality of the rear cap relative to the rest of the housing.

The diameter of the centring surface, as seen in cross section perpendicular to the axial direction, is preferably smaller than the corresponding diameter of the mounting surface, whereby the centring function is optimized. The diameter of the centring surface, as seen in cross section perpendicular to the axial direction, particularly preferably corresponds to the core diameter of the mounting thread, i.e. the two diameters are substantially identical in this case. In that the centring surface is located approximately at the level of the core diameter of the mounting thread, the centring function is maximized.

The mounting section preferably has, next to the mounting surface, as seen in the axial direction opposite the cover section (i.e. at the housing), a cylindrical sealing surface which is provided and designed for sealing the housing, in that a housing seal can be installed between the sealing surface and a corresponding seal seat of the housing. The housing seal is preferably designed as an O-ring. In this way, the rear cap and the remaining housing are reliably sealed in order to prevent water or other external media from passing into the interior of the drive unit.

The diameter of the sealing surface, as seen in cross section perpendicular to the axial direction, is preferably greater than the corresponding diameter of the mounting surface, whereby the housing seal and the mounting thread jointly provide a seal.

The propeller shaft opening preferably has a seal seat for receiving a shaft seal for sealing against the propeller shaft and/or a bearing seat for receiving a bearing, preferably a rolling bearing, for rotatably mounting the propeller shaft, wherein the seal seat preferably has a smaller diameter than the bearing seat, as seen in cross section perpendicular to the axial direction. By integrating the bearing seat and/or seal seat into the rear cap, the drive unit can be constructed particularly compactly.

The rear cap is preferably constructed rotationally symmetrically, whereby the assembly capability and production of the rear cap are further improved.

The rear cap is preferably made of a plastic, whereby the risk of corrosion, in particular galvanic corrosion due to metal pairings, is eliminated. Furthermore, a cost reduction and weight reduction result from the use of a plastic which is lighter than, for example, metal die-cast parts. A coating of the rear cap, for example for avoiding corrosion, can be dispensed with.

In order to further reduce assembly complexity, weight and costs, the rear cap is preferably made in one piece or in one piece.

The abovementioned object is furthermore achieved by a drive unit for an electric outboard motor, wherein the drive unit comprises: a housing with a rear cap according to one of the embodiment variants set out above; an electric motor arranged in the housing and a propeller shaft which is to be driven rotationally by the electric motor and which extends outwards in sections in the axial direction in the housing and through the propeller shaft opening.

The features, technical effects, advantages and exemplary embodiments which have been described with respect to the rear cap apply analogously to the drive unit.

Further advantages and features of the present invention can be seen from the following description of preferred exemplary embodiments. The features described therein can be implemented alone or in combination with one or more of the features set out above, insofar as the features do not contradict one another. The following description of preferred exemplary embodiments is made here with reference to the accompanying drawings.

### BRIEF DESCRIPTION OF THE DRAWINGS

Preferred further embodiments of the invention are explained in more detail by the following description of the figures. In the figures:

FIG. 1 illustrates a perspective external view of an electric drive unit for an outboard motor according to an exemplary embodiment;

FIG. 2 illustrates a sectional view of the rear portion of the drive unit with the rear cap screwed on;

FIG. 3 illustrates a perspective view of the rear cap; and

FIG. 4 illustrates an enlarged detail from the sectional view of FIG. 2 to illustrate the centring of the rear cap.

### DETAILED DESCRIPTION

Exemplary embodiments are described below with reference to the figures. In this case, identical, similar or identically acting elements are provided with identical reference symbols in the figures, and a repeated description of these elements is partially dispensed with in order to avoid redundancy.

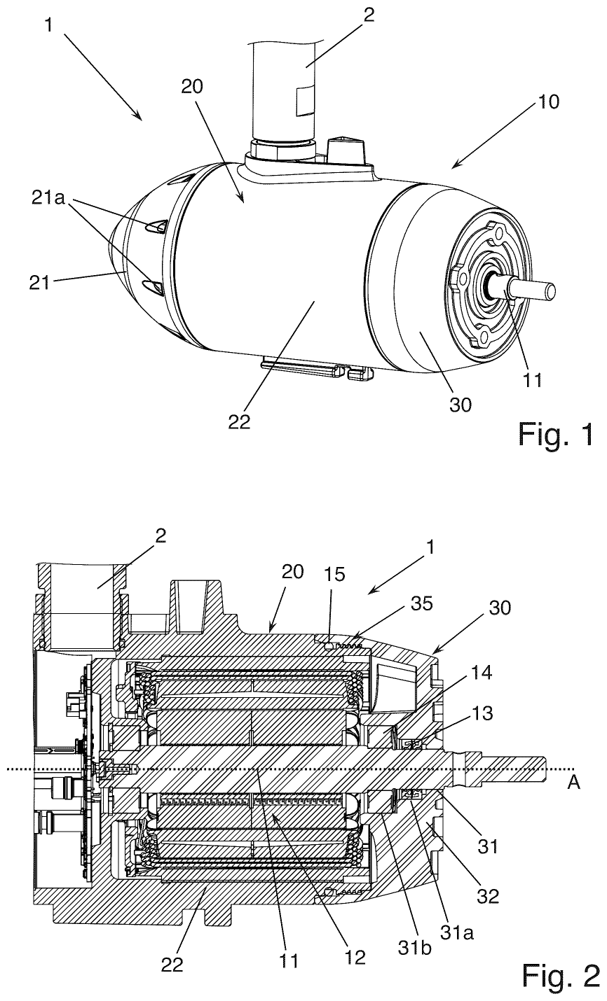

FIG. 1 shows a perspective external view of an electric drive unit 10 for an outboard motor 1 according to an exemplary embodiment. The outboard motor 1 is shown in detail in FIG. 1, wherein the shaft 2, to which the drive unit 10 is fastened, can be seen. Boat-side components, comprising, for example, an accumulator, are not shown in FIG. 1. The drive unit 10 is located below the water surface during normal operation.

The drive unit 10 may also be part of a pod drive and is then likewise arranged below the water surface during normal operation.

The drive unit 10 has a housing 20 which, in the present exemplary embodiment, is constructed substantially in three parts, comprising a dome-shaped, front housing section 21, a cylindrical, middle housing section 22 and a rear cap 30. The overall shape of the housing 20 is preferably optimized in terms of flow dynamics, whereby it can have, in particular, an elongate, rounded, slightly drop-shaped or pylon-shaped geometry. In the present exemplary embodiment, the housing 20 as a whole and the housing sections 21, 22, 30 are constructed substantially rotationally symmetrically.

The front housing section 21 is preferably made of plastic as a front cap and is preferably provided with an internal thread in order to be able to be screwed directly into the middle housing section 22. For this purpose, the front housing section 21 can have depressions 21a which act as engagement points for a tool in order to screw the front housing section 21 tightly. Alternatively, the front housing section 21 and/or the middle housing section 22 can be made of a metallic material, for example in the form of metal die-cast parts.

The rear cap 30 which closes the housing 20 at the rear, i.e. at the propeller side, is preferably made of a plastic.

A propeller shaft 11 which is mounted in the rear cap 30 and projects out of the housing 20 in sections extends in an axial direction in the housing 20. A propeller which is not shown in the figures is fastened to the rear-side end section of the propeller shaft 11 during regular operation.

To drive the propeller shaft 11, the drive unit 10 has an electric motor 12, cf. FIG. 2. The electric motor 12 is preferably a synchronous motor. In the present exemplary embodiment, the electric motor 12 acts as a direct drive, i.e. the electric motor 12 transmits the generated torque directly to the propeller shaft 11 without a transmission. However, the use of a transmission, a clutch etc. is not ruled out.

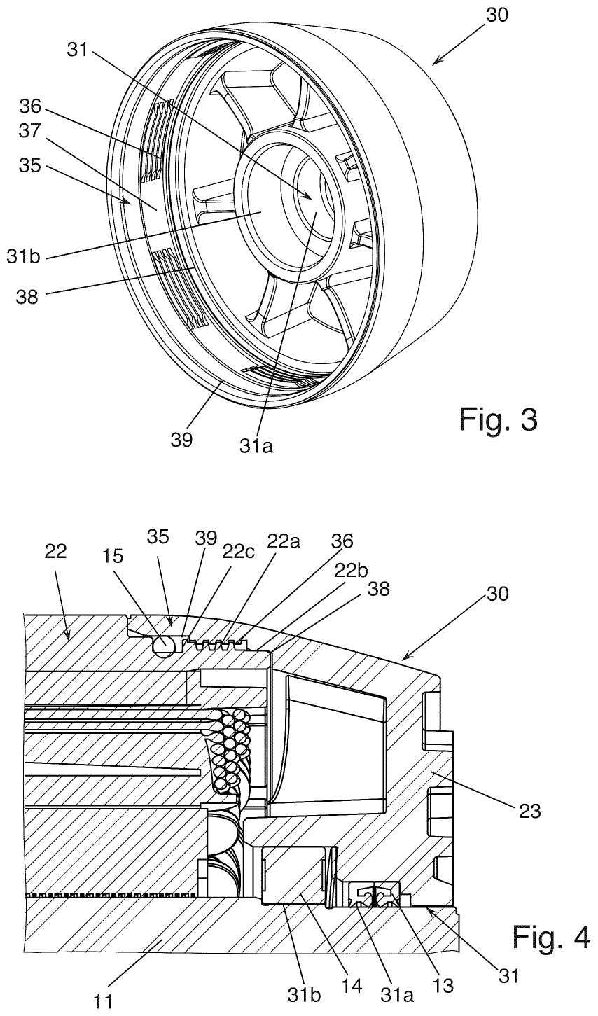

FIG. 3 shows a perspective view of the rear cap 30. The rear cap 30 is a rotationally symmetrical, frustoconical or cylindrical object which is closed by a cover section 32 (cf. FIG. 2) at the rear, i.e. at the propeller side except for a central propeller shaft opening 31 through which the propeller shaft 11 extends out of the housing 20 of the drive unit 10. An axial direction A which coincides with the axial extent of the propeller shaft 11 is defined by the rotationally symmetrical shape of the rear cap 30. At the rear, the rear cap 30 has the cover section 32 which closes the housing 20 at the propeller side. The cover section 32 forms or comprises the cover surface of the “truncated cone” and is closed except for the propeller shaft opening 31, while the rear cap 30 is of rather hollow-cylindrical form on the side facing away from the propeller shaft opening 31 and is open for assembly with the middle housing section 22.

The propeller shaft opening 31 comprises a seal seat 31a. In the assembled state of the drive unit 10, a shaft seal 13 is arranged between seal seat 31a and propeller shaft 11, cf. also FIG. 2. The shaft seal 13 prevents water or other external media from passing into the drive unit 10. The propeller shaft opening 31 furthermore comprises a bearing seat 31b in which, in the assembled state of the drive unit, a bearing 14, in particular rolling bearing, for rotatably mounting the propeller shaft 11 is arranged, cf. also FIG. 2. The bearing seat 31b of the propeller shaft 11 is thus seated in the rear cap 30. The seal seat 31a preferably has a smaller diameter than the bearing seat 31b.

On the side facing away from the propeller shaft opening 31, the rear cap 30 has a hollow-cylindrical mounting section 35 for connection to the middle housing section 22.

The mounting section 35 has a mounting thread 36 which interacts with a corresponding housing-side thread 22a of the middle housing section 22, cf. FIG. 4. The rear cap 30 can thus be screwed as a whole onto a rear-side end section of the middle housing section 22.

The mounting thread 36 is preferably designed as an internal thread and is seated on a cylindrical mounting surface 37 of the mounting section 35, so that its flanks or teeth extend as projections from the mounting surface 37 to the inside, i.e. in the direction of the propeller shaft 11. In addition, the mounting thread 36 does not have to extend completely all the way round over the mounting surface 37, but the mounting thread 36 can, as shown in the present exemplary embodiment of FIG. 3, be provided in sections in groups along the circumference.

At the rear, the cylindrical mounting surface 37 is adjoined by a likewise cylindrical centring surface 38, as seen in the axial direction A, which is designed to ensure centring of the rear cap 30 relative to the middle housing part 22 during the assembly. The mounting surface 37 and the centring surface 38 are inner surfaces of the hollow-cylindrical mounting section 35. The centring surface 38 is preferably at a smaller radial distance from the propeller shaft 11 than the mounting surface 37. In other words, the diameter 37 of the centring surface 38, as seen in cross section perpendicular to the axial direction A, is preferably smaller than the diameter of the mounting surface 37, likewise as seen in cross section perpendicular to the axial direction A. The diameter of the centring surface 38, as seen in cross section perpendicular to the axial direction A, preferably corresponds to the core diameter of the mounting thread 36, i.e. the smallest diameter of the internal thread geometry.

The centring surface 38 enters into a form fit with a corresponding housing-side centring surface 22b of the middle housing section 22 during the assembly of the rear cap 30, as shown in FIG. 4, whereby the axiality of the rear cap 30 relative to the middle housing part 22 is ensured.

At the side of the mounting section 35 facing the middle housing section 22, a sealing surface 39, as seen in the axial direction A, is adjoined, the diameter of which, as seen in cross section perpendicular to the axial direction A, is preferably greater than the corresponding diameter of the mounting surface 37. Housing seal 15, preferably designed as an O-ring, is installed between the sealing surface 39 and a corresponding seal seat 22c of the middle housing part 22, in order to seal the rear cap 30 and the middle housing section 22 with respect to one another.

The rear cap 30, comprising the cover section 32, the mounting section 35, the mounting thread 36, the mounting surface 37, the centring surface 38 and the sealing surface 39, is made of plastic and preferably formed in one piece or in one piece.

The assembly of the rear cap 30 described above is managed by means of the integrated mounting thread without additional fastening means, such as screws, etc. The assembly process is accelerated. The integration of the centring surface 38 additionally increases the reliability of the assembly process, in particular with regard to the axiality of the rear cap 30 relative to the rest of the housing 20.

The risk of corrosion, in particular galvanic corrosion due to metal pairings, is eliminated by the rear cap 30 being made of a plastic. Furthermore, a cost reduction and weight reduction result from the use of a plastic which is lighter than, for example, metal die-cast parts. A coating of the rear cap, for example for avoiding corrosion, can be dispensed with.

To the extent applicable, all individual features which are illustrated in the exemplary embodiments can be combined with one another and/or replaced without departing from the scope of the invention.

### REFERENCE SIGNS

1 outboard motor
2 shaft
10 Electric drive unit
11 Propeller shaft
12 Electric motor
13 Shaft seal
14 Bearing
15 Housing seal
20 Housing
21 Front housing section
21a Depression
22 Middle housing section
22a Housing-side thread
22b Housing-side centring surface
22c Seal seat
30 Rear cap
31 Propeller shaft opening
31a Seal seat
31b Bearing seat
32 Cover section
35 Mounting section
36 Mounting thread
37 Mounting surface
38 Centring surface
39 Sealing surface
A axial direction

What is claimed:

1. A rear cap forming a component of a housing of a drive unit, the rear cap comprising:
a cover section that closes the housing at a rear and includes a propeller shaft opening that defines an axial direction and through which a propeller shaft of the drive unit is guided out of the housing; and
a hollow-cylindrical mounting section that, as seen in the axial direction, is arranged on a side facing away from the propeller shaft opening,
wherein the mounting section has a cylindrical mounting surface with a mounting thread, such that the rear cap is configured to be screwed onto a corresponding housing-side thread of the housing.

2. The rear cap according to claim 1, wherein the mounting thread is configured as an internal thread and is seated on the mounting surface of the mounting section, such that flanks of the mounting thread extend as projections from the mounting surface into an interior of the hollow-cylindrical mounting section.

3. The rear cap according to claim 1, wherein the mounting section has, next to the mounting surface and as seen in the axial direction in the direction of the cover section, a cylindrical centring surface that is configured to ensure centring relative to the housing during the mounting of the rear cap, such that the centering surface enters into a form fit with a corresponding housing-side centring surface of the housing.

4. The rear cap according to claim 3, wherein the diameter of the centring surface, as seen in a cross section perpendicular to the axial direction, is smaller than the corresponding diameter of the mounting surface.

5. The rear cap according to claim 4, wherein the diameter of the centring surface, as seen in the cross section perpendicular to the axial direction, corresponds to the core diameter of the mounting thread.

6. The rear cap according to claim 1, wherein the mounting section has, next to the mounting surface and as seen in the axial direction opposite the cover section, a cylindrical sealing surface that is configured to seal the housing, such that a housing seal can be installed between the sealing surface and a corresponding seal seat of the housing.

7. The rear cap according to claim 6, wherein the diameter of the sealing surface, as seen in a cross section perpendicular to the axial direction, is greater than the corresponding diameter of the mounting surface.

8. The rear cap according to claim 1, wherein the propeller shaft opening has a seal seat configured to receive a shaft seal for sealing against the propeller shaft.

9. The rear cap according to claim 8, wherein the seal seat has a smaller diameter than the bearing seat as seen in a cross section perpendicular to the axial direction.

10. The rear cap according to claim 1, wherein the propeller shaft opening has a bearing seat configured to receive a bearing for rotatably mounting the propeller shaft.

11. The rear cap according to claim 1, wherein the rear cap is constructed rotationally symmetrically.

12. The rear cap according to claim 1, wherein the rear cap comprises a plastic.

13. The rear cap according to claim 1, wherein the rear cap is formed of a singular piece.

14. A drive unit for an electric outboard motor, the drive unit comprising:
a housing with a rear cap that includes:
a cover section that closes the housing at a rear and includes a propeller shaft opening that defines an axial direction and through which a propeller shaft of the drive unit is guided out of the housing; and
a hollow-cylindrical mounting section that, as seen in the axial direction, is arranged on a side facing away from the propeller shaft opening,
wherein the mounting section has a cylindrical mounting surface with a mounting thread, such that the rear cap is configured to be screwed onto a corresponding housing-side thread of the housing;
an electric motor arranged in the housing; and
a propeller shaft configured to be driven rotationally by the electric motor and that extends outwards in sections in the axial direction in the housing and through the propeller shaft opening.

15. The drive unit cap according to claim 14, wherein the mounting thread is configured as an internal thread and is seated on the mounting surface of the mounting section, such that flanks of the mounting thread extend as projections from the mounting surface into an interior of the hollow-cylindrical mounting section.

16. The drive unit cap according to claim 14, wherein the mounting section has, next to the mounting surface and as seen in the axial direction in the direction of the cover section, a cylindrical centring surface that is configured to ensure centring relative to the housing during the mounting of the rear cap, such that the centring surface enters into a form fit with a corresponding housing-side centring surface of the housing.

17. The drive unit cap according to claim 16, wherein the diameter of the centring surface, as seen in a cross section perpendicular to the axial direction, is smaller than the corresponding diameter of the mounting surface.

18. The drive unit cap according to claim 17, wherein the diameter of the centring surface, as seen in the cross section perpendicular to the axial direction, corresponds to the core diameter of the mounting thread.

19. The drive unit cap according to claim 14, wherein the mounting section has, next to the mounting surface and as seen in the axial direction opposite the cover section, a cylindrical sealing surface that is configured to seal the housing, such that a housing seal can be installed between the sealing surface and a corresponding seal seat of the housing.

20. The drive unit cap according to claim 19, wherein the diameter of the sealing surface, as seen in a cross section perpendicular to the axial direction, is greater than the corresponding diameter of the mounting surface.
